(19) United States
(12) Patent Application Publication
(10) Pub. No.: US 2020/0299072 A1
(43) Pub. Date: Sep. 24, 2020

(54) Method and Device for the Hydraulic Forced-Supply Filling of Cases with Floating Objects

(71) Applicant: MAF AGROBOTIC, MONTAUBAN (FR)

(72) Inventor: Philippe BLANC, MONTAUBAN (FR)

(21) Appl. No.: 16/085,863

(22) PCT Filed: Mar. 23, 2017
(86) PCT No.: PCT/EP2017/057023

§ 371 Date: Sep. 17, 2018

(30) Foreign Application Priority Data
Mar. 25, 2016 (FR) 16.52642

(51) Int. Cl. B65G 51/01; B65B 25/04

(52) U.S. Cl. CPC B65G 51/01; B07C 5/36; B65B 25/046; B65B 25/045

(57) ABSTRACT

The invention relates to a method and a device for hydraulically filling cases with floating objects in which at least one case to be filled is immersed in a receiving tank, during a step of supplying the tank with floating objects, floating objects are transported to the tank by a hydraulic stream of a supply channel (13) communicating with the tank above an immersed case. During at least part of the supplying step, floating objects are forced to move downstream in the hydraulic stream of the supply channel at a speed greater than that of the hydraulic stream.

The invention relates to a method and a device for the hydraulic filling of cases—in particular cases which are water-permeable but are able to contain objects, such as open crates and/or box pallets, generally known under the name palox—for storing or transporting large amounts (typically several hundred kilos) of fruit or vegetables or other floating objects.

There are already known (FR1485753, FR2036095, U.S. Pat. Nos. 5,242,250, 7,159,373 . . . ) devices for filling cases with floating objects such as fruit or vegetables, for example apples. Such a device comprises a tank for receiving a case to be filled, a device for loading/unloading a case into/from the tank and a channel for supplying a hydraulic stream in the upper part of the tank. A pump is provided to suck in the liquid stream drawn from the bottom of the tank and to recycle it upstream of the supply channel, and thereby ensure a flow through the tank so as to fill the case with objects floating in the stream entering the supply channel.

The problem which has arisen for a long time with these devices in which the operation is, by design, discontinuous, is that of the productivity of the method for filling the cases, i.e. optimising the overall rate of filling of the cases with objects. In fact, such a filling device generally located in the downstream portion of a device for sorting floating objects, e.g. a device for calibrating fruit, is the factor limiting the overall rate and general productivity of this sorting device. This problem is more and more acute as modern devices for calibrating or pre-calibrating fruit are constantly being improved and have higher and high operating rates and speeds.

For this purpose, FR1485753 provides a rounded overflow-chute forming a cross-section restriction at the end of the supply channel to accelerate the hydraulic stream and the fruit entering the tank. FR2596728 provides profiled guides allowing the floating objects to be channelled to a cylindrical opening in a plate covering the immersed case. These structural designs of the filling device have limited efficiency in relation to the improvement of the productivity of the filling of the cases with objects.

FR2175630 recommends fitting a hydraulic transport channel with mobile scoops allowing, in the raised position, fruit to be retained and the height of the hydraulic stream upstream of the scoops to be increased and, in the lowered position, the hydraulic stream and the fruit to be released so as to momentarily increase the flow rate downstream of the scoops. However, this solution does not allow the productivity of the filling method to be increased because it consists, in contrast, of slowing down the hydraulic stream and the fruit.

Other documents such as GB 1571400 provide a vacuum chamber placed above the tank and a conveyor inclined downwardly to immerse the products so as to introduce them into the vacuum chamber which creates an upwards depression. U.S. Pat. No. 4,051,645 also describes a device comprising a conveyor inclined downwardly to immerse apples at the end of a hydraulic channel in a receiving station for supplying them into a transfer cage having a lower opening and an upper opening, and then allowing them to be loaded into a case. These solutions are complex, costly and do not sufficiently improve the supply rate of the filling device. The invention thus aims to overcome all of these disadvantages by proposing a method and a device for filling cases with floating objects, having a considerably improved rate and thus productivity.

The invention aims in particular to propose such a filling method and such a filling device having a flow and productivity which are in particular compatible with the modern devices for sorting floating objects such as the high-speed and high-rate devices for calibrating or pre-calibrating fruit.

The invention likewise aims to propose a device for sorting floating objects such as fruit or vegetables allowing the implementation of such a filling method and/or comprising such a filling device and having the same advantages.

The invention likewise aims to achieve these aims without requiring any modifications to the hydraulic channels nor to the general design of the filling device or sorting device, and to do so in simple, quick and less expensive manner. It thus aims in particular to achieve these aims by simply adding on an optional device which is simple and inexpensive. It thus aims in particular to allow a simple and inexpensive modification of the filling devices and/or sorting devices currently in use to considerably increase their overall rate and general productivity.

The invention thus relates to a method for the hydraulic filling of cases—in particular cases which are water-permeable but are able to contain objects, such as open crates and/or box pallets, generally known under the name palox—with objects, named floating objects, able to be transported by a hydraulic stream, such as fruit or vegetables, in which:

at least one case to be filled is immersed in a receiving tank,

during a step of supplying the tank with floating objects, said floating objects are transported to the tank by a hydraulic stream of a supply channel communicating with the tank above an immersed case,

characterised in that during at least part of the supplying step, at least some of the floating objects are mechanically forced to move downstream in the hydraulic stream of the supply channel at a mechanical forced-movement speed which is greater than their forced-movement speed, named hydraulic forced-movement speed, downstream solely under the effect of the hydraulic stream, so as to repel them downstream towards the tank and to accelerate their movement speed in the hydraulic stream towards the tank.

Therefore, at least some of said floating objects are mechanically forced (i.e. by a mechanism) downstream and are not forced solely hydraulically by the speed of the hydraulic stream. In a method in accordance with the invention, the mechanically forced floating objects are thus forced at a mechanical forced-movement speed which is greater than their forced-movement speed, named hydraulic forced-movement speed, downstream solely under the effect of the hydraulic stream. It should be noted that this hydraulic forced-movement speed does not necessarily correspond precisely to the speed of the hydraulic stream. It is generally slightly less than the flowrate of the hydraulic stream in the supply channel. Consequently, it is necessary and sufficient, in the principle of the invention, that the floating objects are mechanically forced downstream at a mechanical forced-movement speed greater than the hydraulic forced-movement speed of the floating objects, so as to repel them downstream towards the tank and to accelerate their movement speed in the hydraulic stream towards the tank. This mechanical forced-movement speed can thus be, at least in theory, less than the flowrate of the hydraulic stream in the supply channel.

That being said, in some advantageous embodiments in accordance with the invention, said floating objects mechanically forced to move downstream are mechanically forced downstream in the hydraulic stream at a speed greater than the flowrate of the hydraulic stream in the supply channel.

The act of mechanically forcing at least some of the floating objects downstream at a mechanical forced-movement speed greater than their hydraulic forced-movement speed—in particular greater than the flowrate of the hydraulic stream—allows in particular considerable improvement and acceleration in the filling of the case in a simple and economic manner without risk to the floating objects which may be delicate objects such as fruit or vegetables, e.g. apples or citrus fruit. In should be noted in this regard that such a mechanical forced movement in the supply channel not only increases the general downstream horizontal movement speed of the floating objects (while floating on the surface of the hydraulic stream), and thus thereby the rate of supplying the floating objects into a case immersed in the tank, but also improves the packing and width-wise distribution of the floating objects in this supply channel, also optimising the supply rate of the tank, and thus of the case immersed in this tank.

In a method in accordance with the invention, any device allowing floating objects to be mechanically forced to move downstream whilst floating on the surface of the hydraulic stream can be used. In some embodiments, advantageously and in accordance with the invention, in order to mechanically force floating objects to move downstream, at least one gate, named feeding gate, adapted to be able to mechanically force floating objects in the hydraulic stream downstream, is forced to move downstream with respect to the supply channel at a speed selected to come into contact with floating objects in the hydraulic stream, to push them and to accelerate the movement thereof towards the tank. In particular, the downstream forced-movement speed of such a feeding gate is selected to be greater than said hydraulic forced-movement speed of the objects in the hydraulic stream—in particular greater than the flowrate of the hydraulic stream in the supply channel. Such a feeding gate can be formed of teeth spaced apart from each other by a width less than the smallest size of the floating objects to be able to force them downstream in the hydraulic stream in the manner of a rake. Such a feeding gate is transparent to the hydraulic stream which can freely pass therethrough, substantially without any head loss or reduction in speed.

In a method in accordance with the invention, it is possible to thus mechanically force downstream all or some of the floating objects in a single batch of floating objects intended to fill a single case. In some advantageous embodiments of a method in accordance with the invention, all of the floating objects of a single batch of floating objects intended to fill a single case are mechanically forced to move downstream in the hydraulic stream of the supply channel.

In particular, in some advantageous embodiments of a method in accordance with the invention, the floating objects of a batch of floating objects intended to fill a single case are introduced into the supply channel progressively one behind the other and a feeding gate is placed immediately upstream of the last floating objects of this batch introduced into the supply channel, then this feeding gate is forced to move downstream in the hydraulic stream (at a speed greater than the hydraulic forced-movement speed of the floating objects—in particular greater than the flowrate of the hydraulic stream).

Furthermore, such a method in accordance with the invention is particularly advantageous when the floating objects are introduced on one side of the supply channel, in a direction transverse to this supply channel, in particular from hydraulic accumulating channels (allowing sorting of the floating objects in accordance with predetermined sorting criteria such as size, weight, optical analyses . . . , each accumulating channel receiving a batch of floating objects sorted in accordance with said sorting criteria) extending perpendicularly to the supply channel, this latter extending longitudinally along outlets of these accumulating channels. In fact, the floating objects thus introduced on one side of the supply channel tend to spread out and be dispersed in the supply channel, moving away from each other and to take up only some of the width thereof. Consequently, the act of mechanically forcing them downstream results, if the mechanical forced-movement speed of the floating objects is sufficient, in the objects being brought together again and being spread out width-wise such that the entire width of the supply channel is taken up by floating objects before they arrive at the tank, and the supply of objects thereby grouped together into a case immersed in the receiving tank being ensured. Therefore, in particular in these embodiments, the floating objects are advantageously mechanically forced downstream at a mechanical forced-movement speed selected to bring them together and to spread them out width-wise across the entire width of the supply channel before they arrive at the tank whilst floating on the surface of the hydraulic stream. That being said, there is nothing to prevent, in contrast, the provision of a mechanical forced-movement speed slightly less than that necessary to bring the floating objects together, if it proves to be the case that such bringing together is harmful, e.g. may cause damage to the objects. A filling method in accordance with the invention thereby produces forced supply of the immersed case with floating objects, i.e. a type of force-feeding of the case.

Likewise, a filling method in accordance with the invention is particularly advantageous when the hydraulic stream in the supply channel passes into the tank and through the case immersed therein downwards to leave the tank via a lower outlet thereof. In fact, in these embodiments, mechanically forcing the objects downstream at the inlet of the tank of the case immersed in the latter produces a forced supply (force-feeding) of the case with floating objects which is particularly efficient and quick.

The invention likewise relates to a device for hydraulically filling cases—in particular open crates—with objects, named floating objects, able to be transported by a hydraulic stream, such as fruit or vegetables, for implementing a filling method in accordance with the invention.

It thus relates likewise to a device for the hydraulic filling of cases—in particular cases which are water-permeable but are able to contain objects, such as open crates and/or box pallets, generally known under the name palox—with objects, named floating objects, able to be transported by a hydraulic stream, such as fruit or vegetables, comprising:

a tank for receiving at least one case to be filled,

at least one supply channel communicating with the tank above a case immersed in the tank,

a pumping circuit able to maintain a hydraulic stream in each supply channel, the hydraulic stream being suitable to transport floating objects to the tank, characterised in that it comprises a feeding device adapted to be able to, at least during part of a step of supplying the tank with floating objects, mechanically force at least some of the floating objects to move downstream in the hydraulic stream of the supply channel at a mechanical forced-movement speed which is greater than their forced-movement speed, named hydraulic forced-movement speed, downstream solely under the effect of the hydraulic stream, so as to repel them downstream towards the tank and to accelerate their movement speed in the hydraulic stream towards the tank.

In a filling device in accordance with the invention, any feeding device able to mechanically force floating objects can be used.

In some advantageous embodiments in accordance with the invention, the feeding device is adapted to be able to mechanically force floating objects to move downstream at a mechanical forced-movement speed greater than the forced-movement speed, named hydraulic forced-movement speed, of the floating objects downstream solely under the effect of the hydraulic stream—in particular at a mechanical forced-movement speed greater than the flowrate of the hydraulic stream in the supply channel.

In some advantageous embodiments in accordance with the invention, the feeding device comprises at least one gate, named feeding gate, adapted to be able to mechanically force floating objects in the hydraulic stream downstream, and a mechanism for forcing each feeding gate to move downstream with respect to the supply channel at a speed selected such that the feeding gate comes into contact with floating objects in the hydraulic stream, pushes them and accelerates the movement thereof towards the tank in the hydraulic stream.

Furthermore, in some advantageous embodiments in accordance with the invention, the feeding device comprises, as a forced-movement mechanism, a self-propelled carriage adapted to be able to move in translation on at least one sidewall of the supply channel. This self-propelled carriage carries at least one motor for driving the self-propelled carriage along the supply channel, and advantageously a feeding gate and at least one actuator adapted to force the feeding gate to move between an active position in which it is able to come into contact with floating objects in the hydraulic stream of the supply channel, and an inactive position in which it is not able to co-operate with floating objects in the hydraulic stream of the supply channel.

This self-propelled carriage can advantageously be guided with respect to only one of the sidewalls of the supply channel, e.g. by being provided with rollers rolling on an upper border of the sidewall of the supply channel and with a column having a lower end guided in a chute extending longitudinally to the outside of the sidewall, integral therewith. As a variant, there is nothing to prevent provision of a self-propelled carriage straddling the supply channel, rolling on the two sidewalls thereof, above the hydraulic stream. As another variant, there is also nothing to prevent a self-propelled carriage being guided with respect to a specific guiding device other than the sidewalls of the supply channel.

The forced-movement mechanism is also adapted to move the feeding gate upstream with respect to the supply channel so as to allow this feeding gate to return to a position where it can co-operate with a new group of floating objects intended to be supplied to a case to be filled.

Such a feeding gate and its forced-movement mechanism are advantageously adapted such that the feeding gate can be forced to move downstream in the downstream part of the supply channel which extends to the tank. However, as a variant, there is nothing to prevent provision being made, in contrast, for the feeding gate to co-operate with the floating objects only over some of the length of the supply channel, optionally without being moved to the tank.

Furthermore, the forced-movement mechanism can be controlled in any suitable manner such that the feeding device co-operates with all or some of the floating objects in the supply channel. In particular, there is nothing to prevent the introduction of the feeding gate within a group of floating objects to force only some of the floating objects of this group downstream. That being said, in some advantageous embodiments, the feeding device has a feeding gate adapted to be able to be moved and introduced into the hydraulic stream of the supply channel in an introduction position located at a distance away from the tank determined such that a single batch of floating objects able to be contained within a single case and transported by the hydraulic stream can be fully contained between the introduction position of the feeding gate and the tank. In this manner, the feeding gate can co-operate with all of the floating objects of a single batch of floating objects able to be contained in a single case in order to mechanically force them downstream and to increase their supply rate within the tank, and thus the case.

In some advantageous embodiments of a filling device in accordance with the invention, the supply channel has a cross-section restriction at one end communicating with the tank of this supply channel. In these embodiments, advantageously and in accordance with the invention, the feeding device comprises at least one feeding gate upstream of this cross-section restriction. This feeding gate is thus able to be forced to move downstream by the forced-movement mechanism at a speed greater than that of the hydraulic stream, and upstream to be moved back to the initial position, the feeding gate remaining upstream of the cross-section restriction during all of its movements.

Furthermore, in some advantageous embodiments of a filling device in accordance with the invention, the supply channel extends along a plurality of outlets of a plurality of channels accumulating floating objects, these accumulating channels being in parallel with each other, each outlet of an accumulating channel communicating with the supply channel on one side thereof. The feeding device of such a filling device in accordance with the invention thus allows the floating objects to be contacted—in particular for them to be brought together—and allows the width-wise distribution of the floating objects in the supply channel upstream of the tank to be improved, which optimises not only the speed and rate of filling of a case immersed in the tank but also the quality of this filling, by minimising shocks and the risks of damage to the floating objects.

Furthermore, in some advantageous embodiments and in accordance with the invention, in particular when the number of accumulating channels is high, the supply channel comprises at least one gate, named intermediate gate, adapted to be able to be placed either in the active position in the supply channel in which it holds back the floating objects transported by the hydraulic stream upstream of the intermediate gate, or in an inactive position in which it does not co-operate with floating objects in the hydraulic stream. Such an intermediate gate allows the optimisation of the sequences of introducing, into the supply channel, the different batches of floating objects from different accumulating channels. In particular, a batch of floating objects can be introduced into the supply channel upstream of an intermediate gate from an accumulating channel located upstream of this intermediate gate, whilst another batch of floating objects previously introduced into the supply channel downstream of the intermediate gate from an accumulating channel located downstream of the intermediate gate is supplied into the tank and into a case, the floating objects of this batch being forced to move downstream at a speed greater than that of the hydraulic stream by the feeding device.

Advantageously and in accordance with the invention, the feeding device thus comprises a feeding gate between the tank and such an intermediate gate, this intermediate gate being located further downstream in the supply channel. There is likewise nothing to prevent the possible provision of a feeding gate upstream of an intermediate gate, or between two intermediate gates.

Likewise, in some advantageous embodiments of a filling device in accordance with the invention, said pumping circuit is adapted to force the hydraulic stream to flow downwards in the tank and through a case immersed in this tank. In this manner, the forced supply resulting from the feeding device is even more efficient.

The invention likewise relates to a filling method implemented with a filling device in accordance with the invention.

The invention likewise relates to a device for sorting floating objects such as fruit or vegetables, comprising:

at least one conveyor for sorting floating objects in accordance with predetermined sorting criteria and adapted to discharge floating objects into hydraulic accumulating channels,

at least one device for hydraulically filling cases—in particular open crates—with floating objects, comprising:
a tank for receiving at least one case to be filled,
at least one channel for supplying a hydraulic stream extending between outlets of the accumulating channels and the receiving tank, each supply channel being able to transport floating objects exiting an accumulating channel, and communicating with the tank above a case immersed in the tank,

a pumping circuit able to maintain a hydraulic stream in each accumulating channel and in each supply channel, the hydraulic stream being suitable to transport floating objects to each receiving tank, characterised in that each device for hydraulically filling cases is a filling device in accordance with the invention.

The invention likewise relates to a filling device, a filling method and a sorting device which are characterised in combination by all or some of the features mentioned above or below.

Other aims, features and advantages of the invention will become apparent upon reading the following description given by way of non-limiting example and which makes reference to the attached figures in which:

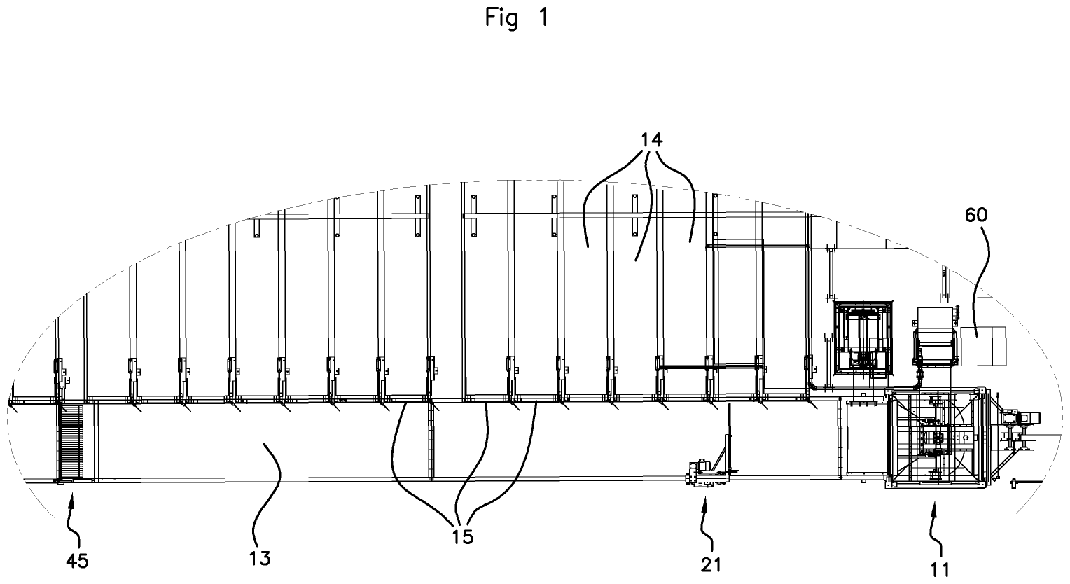

FIG. 1 is a partial schematic top view of a filling device in accordance one embodiment of the invention in a sorting device in accordance with one embodiment of the invention,

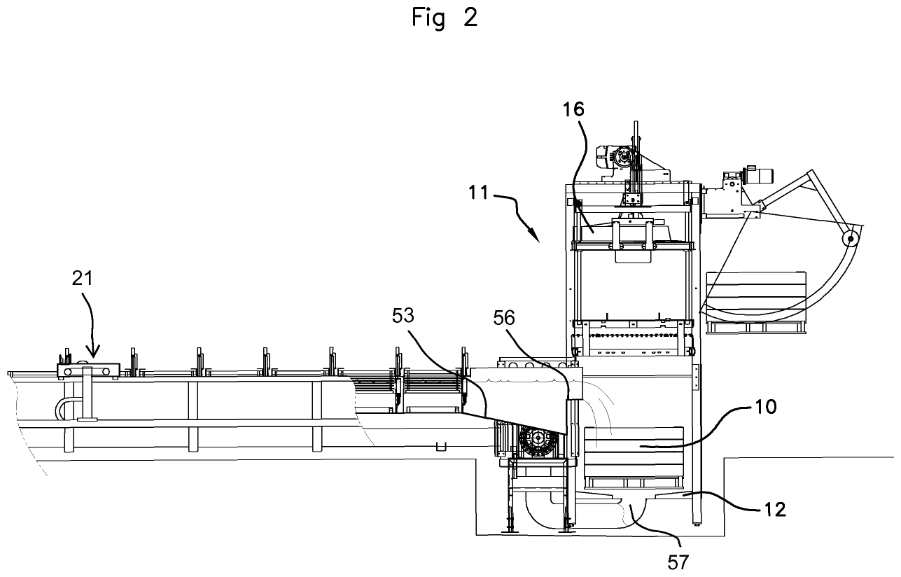

FIG. 2 is a partial schematic elevation of the filling device of FIG. 1,

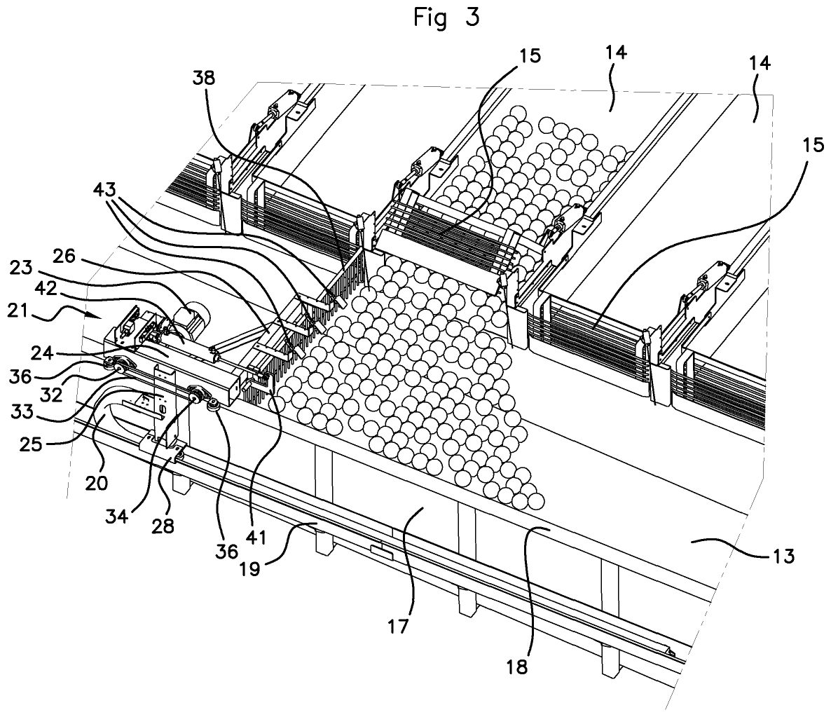

FIG. 3 is a partial schematic perspective view of a feeding device of a filling device in accordance with the invention in the introduction position during a step of a filling method in accordance with the invention during which a batch of floating objects is introduced into the supply channel downstream of the feeding device from a accumulating channel,

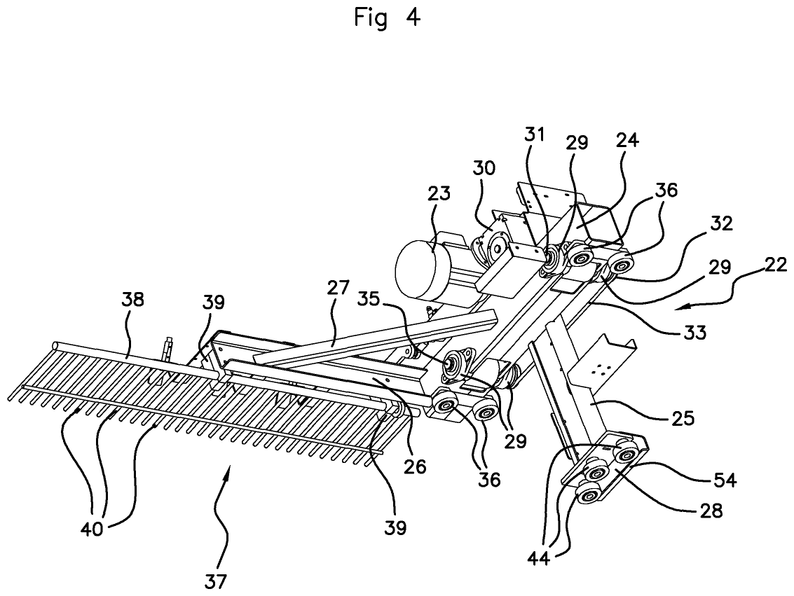

FIG. 4 is a partial schematic perspective bottom view of a feeding device of a filling device in accordance with one embodiment of the invention,

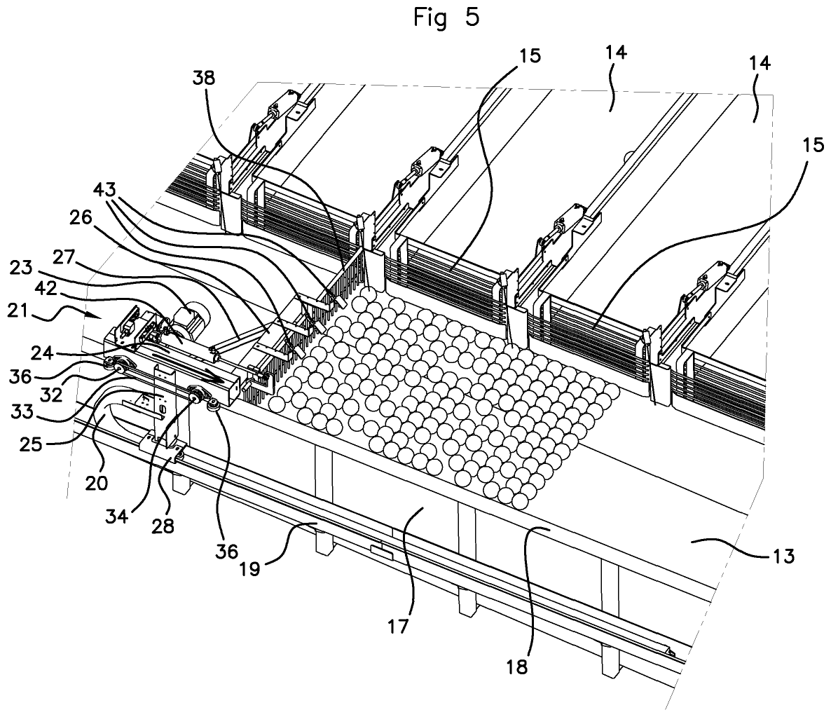

FIG. 5 is a view similar to FIG. 3 illustrating a later step of a filling method in accordance with the invention,

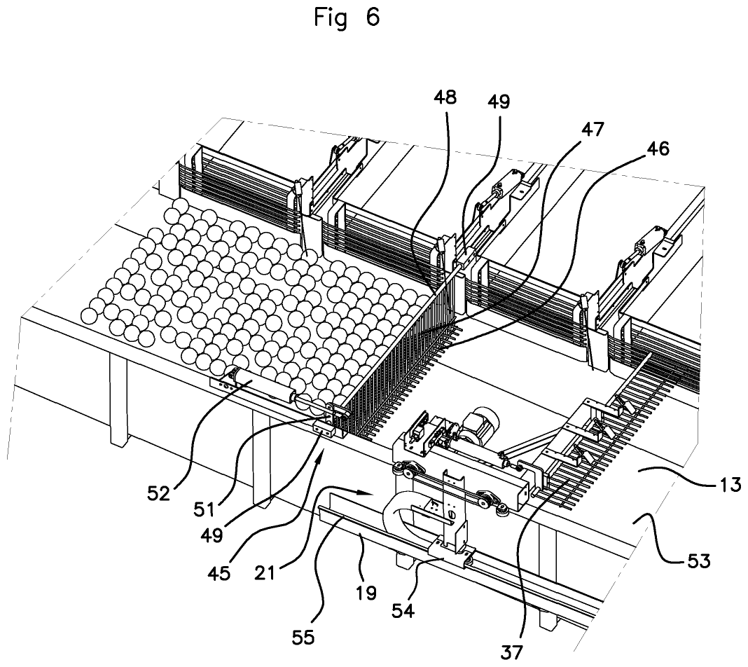

FIG. 6 is a view similar to FIG. 3 illustrating a step of a filling method in accordance with the invention during which the feeding device is in the inactive position immediately downstream of an intermediate gate against which accumulate floating objects from an accumulating channel, the outlet of which is upstream of the intermediate gate,

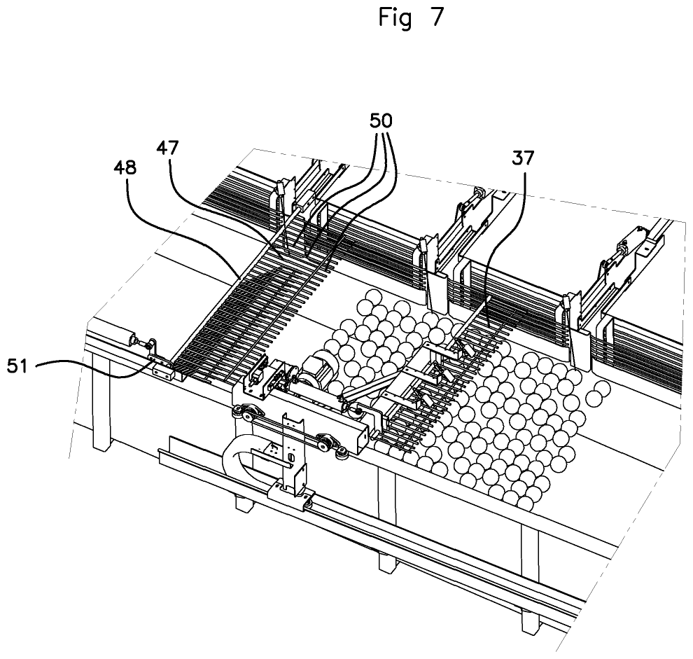

FIG. 7 is a view similar to FIG. 6 illustrating a subsequent step of the method in accordance with the invention during which the floating objects pass beneath the feeding gate of the feeding device.

FIG. 1 shows the downstream part of a sorting device in accordance with the invention comprising a plurality of hydraulic accumulating channels 14 in parallel with each other and supplied by a sorting conveyor (not shown) in a conventional manner so as to allow floating objects such as fruit or vegetables to be grouped into batches in the accumulating channels, the floating objects of a single batch meeting the same sorting criteria (e.g. same size, same weight, same colour . . . ) and being intended to fill the same case 10. The hydraulic channels 14 are supplied by a hydraulic stream by way of a pumping device. Each accumulating channel 14 has an outlet 15 provided with a mobile gate allowing the hydraulic stream to pass therethrough and either allowing the floating objects to be retained within the accumulating channel or to allow the floating objects to pass into a hydraulic supply channel 13 which extends along different outlets 15 of different accumulating channels 14, perpendicularly to these accumulating channels 14.

The general features of such a sorting device are well known per se (cf. in particular U.S. Pat. Nos. 5,626,238, 7,159,373, . . . ) and only the features unique to the invention will be described in more detail hereinafter. This sorting device is in particular provided with a device 11 for hydraulically filling cases 10—in particular cases which are water-permeable but are able to contain objects, such as open crates and/or box pallets, generally known under the name palox—with floating objects. Again, the general features of such a hydraulic filling device implementing a method for hydraulically filling cases with floating objects are well known per se (cf. in particular the documents mentioned above) and only the features unique to the invention will be described in more detail hereinafter. Throughout the text, the terms “downstream” and “upstream” refer to the flow direction of the hydraulic stream in the channels.

The filling device 11 comprises, at the downstream end of the supply channel 13, a tank 12 for receiving at least one case 10 to be filled with objects, this case 10 being immersed in the tank 12. The supply channel 13 communicates with the tank 12 above a case 10 immersed in the tank 12 such that the hydraulic stream provided in the supply channel 13 passes into the tank 12 and into the case 10 contained therein so as to introduce the floating objects transported by the hydraulic stream into the case. The filling device 11 likewise comprises a device 16 for loading/unloading cases 10 into/from the tank 12 which is e.g. an elevator device, and an automatic control arrangement 60, comprising e.g. in particular a computer system, and adapted to control the different members, actuators and motors of the filling device in accordance with the invention and to implement a filling method in accordance with the invention.

The supply channel 13 has a base 53 and vertical sidewalls 17, including one vertical sidewall 17 extending longitudinally at a distance from the outlets 15 of the accumulating channels 14, this sidewall 17 having a free upper horizontal border 18 and a U-shaped profile extending longitudinally to the outside of the sidewall 17 beneath the upper border 18 so as to form a chute 19 receiving a flexible sleeve 20.

A feeding device 21 is associated with the sidewall 17 so as to be able to move in translation longitudinally along this sidewall 17, on its upper border 18, in either direction. In the illustrated embodiment, this feeding device 21 is a self-propelled device comprising a self-propelled carriage having a mechanically welded frame 22 bearing an electric motor 23 for forcing the feeding device 21 to move along the upper border 18.

The mechanically welded frame 22 comprises a horizontal main beam 24, a horizontal cross-beam 26 perpendicular to the beam 24, a reinforcement 27 placed between the beam 24 and the cross-beam 26 to keep them perpendicular to each other, and an outer vertical column 25 extending downwards from the beam 24 such that when the beam 24 is above the upper border 18 of the sidewall 17, the lower end 28 of the column 25 co-operates with the chute 19. To do this, this lower end 28 of the column 25 is provided with rollers 44 which can freely rotate about vertical axles rolling on vertical walls of the chute 19 so that it is guided thereby and held therein to prevent tipping of the mechanically welded frame 22 and the cross-beam 26 in the supply channel 13. Furthermore, the lower end 28 of the column 25 can be provided with an angle-beam 54 co-operating with an upper outer lap 55 of the chute 19 allowing this lower end 28 to be locked in the chute 19. This angle-beam 54 is integral with a piece which is connected, e.g. bolted, to the lower end 28 of the column 25, this lower end having been placed in the chute 19.

The beam 24 is provided with rollers allowing it to roll on the upper border 18 of the sidewall 17 of the supply channel and allowing it to be guided horizontally with respect to the sidewall 17. The beam 24 bears four bearing rollers 29 mounted so as to rotate with respect to the beam 24 on horizontal axes of rotation, at least one of the bearing rollers 29 being forced to rotate by the motor 23. To do this, the motor 23 is coupled to a transmission block 30 itself coupled to a horizontal transverse shaft 31 rotatably guided with respect to the beam 24 and bearing two bearing rollers 29 fixedly attached to this transverse shaft 31 for conjoint rotation therewith, one bearing roller 29 on either side of the beam 24. Furthermore, the transverse shaft 31 likewise forces a pulley 32 to rotate which drives a belt 33 driving a pulley 34 coupled to a second horizontal transverse shaft 35 rotatably guided with respect to the beam 24 and bearing two other bearing rollers 29 fixedly attached to this transverse shaft 35 for conjoint rotation therewith, one bearing roller 29 on either side of the beam 24. Therefore, the beam 24 is supported and forced to move along the upper border 18 by four bearing rollers 29 forced to rotate by the motor 23 in either direction. The motor 23 is fed and controlled by the automatic control arrangement 60 via cables integrated in the flexible sleeve 20. Upon movement of the feeding device 21 along the upper horizontal border 18 of the sidewall 17 of the supply channel 13, the flexible sleeve 20 follows the mechanically welded frame 22 exiting the chute 19 to varying extents or remaining to varying extents in this chute 19.

The upper border 18 of the sidewall 17 of the supply channel is formed by a flange turned back towards the outside of the upper part of this sidewall 17. The beam 24 is guided horizontally with respect to this turned-back flange by rollers 36 mounted so as to rotate freely about vertical axles and spaced apart from each other so as to co-operate by rolling with longitudinal side flanks of this turned-back flange. In this manner, the beam 24, and thus the self-propelled feeding device 21, is obliged to move along the upper border 18.

The feeding device 21 bears a feeding gate 37 extending on the side of the beam 24 above the supply channel 13. This feeding gate 37 comprises a transverse horizontal bar 38 rotatably guided with respect to the cross-beam 26 of the mechanically welded frame 22 by at least two bearings 39. The feeding gate 37 likewise comprises mutually parallel teeth 40 extending perpendicularly to and from the horizontal bar 38. The teeth 40 are laterally spaced apart from each other at a distance less than the smallest dimension of the floating objects to be processed. They are also as thin as possible so as to allow the hydraulic stream to pass through the feeding gate 37 with minimal head losses. However, they are rigid enough to allow the floating objects to be forced along with respect to the hydraulic stream, at a speed different from the speed of the hydraulic stream. They are long enough to be able to co-operate with floating objects forced along by the hydraulic stream in the supply channel 13 when said teeth extend vertically downwards from the horizontal bar 38.

The horizontal bar 38 bears a bracket 41 fixedly attached to this bar for conjoint rotation therewith and of which the end is articulated to the actuating rod of a cylinder 42, the body of which is supported by the beam 24. The cylinder 42 allows the horizontal bar 38 and thus the feeding gate 37 to be forced to rotate with respect to the cross-beam 26 at least between an inactive position of the feeding gate 37 in which the teeth 40 extend horizontally above the supply channel 13, without co-operating with the hydraulic stream nor with the floating objects possibly transported by this hydraulic stream, these floating objects being able to pass beneath the feeding gate 37; and an active position of the feeding gate 37 in which the teeth 40 extend vertically downwards to co-operate with the hydraulic stream and the floating objects of the supply channel 13. The cylinder 42 is fed and controlled by the automatic control arrangement 60 via flexible conduits integrated in the sleeve 20.

The cross-beam 26 likewise advantageously bears a plurality of photoelectric cells 43 allowing the detection of the presence or absence of floating objects in the supply channel 13 immediately downstream of the feeding gate 37, these photoelectric cells 43 being likewise connected to the automatic control arrangement 60 by suitable cables integrated in the sleeve 20.

Furthermore, the filling device likewise comprises a transverse intermediate gate 45, the longitudinal position of which is fixed with respect to the supply channel 13, but adapted to be able to be placed either in the active position in the supply channel 13 in which it holds back the floating objects transported by the hydraulic stream arriving upstream of the intermediate gate, or in an inactive position in which it does not co-operate with the hydraulic stream and allows the floating objects transported thereby to pass downstream.

In the embodiment illustrated in the figures, this intermediate gate 45 is formed of a lower fixed gate 46 rigidly fixed in the supply channel 13 between its two sidewalls 17 and extending upwards from the base of the supply channel 13, and an upper mobile gate 47 comprising a transverse horizontal bar 48 rotatably guided by bearings 49 above the supply channel 13 and teeth 50 supported by the transverse horizontal bar 48 and extending perpendicularly to and from this latter. The teeth 50 are mutually parallel and laterally spaced apart from each other at a distance less than the smallest dimension of the floating objects to be processed. They are as thin as possible so as to allow the hydraulic stream to pass through the gate 45 with minimal head losses. However, they are rigid enough to hold back the floating objects with respect to the hydraulic stream when they extend vertically downwards in the active position from the horizontal bar 48.

The horizontal bar 48 bears a bracket 51 fixedly attached to this bar for conjoint rotation therewith and of which the end is articulated to the actuating rod of a cylinder 52, the body of which is supported by the upper border 18 of the sidewall 17 of the supply channel 13. The cylinder 52 allows the horizontal bar 48 and thus the mobile intermediate gate 47 to be forced to rotate with respect to the supply channel 13 at least between an inactive position of the intermediate gate 45 in which the teeth 50 of the mobile gate 47 extend horizontally above the supply channel 13, without co-operating with the hydraulic stream nor with the floating objects possibly transported by this hydraulic stream, these floating objects being able to pass beneath the mobile intermediate gate 47; and an active position of the intermediate gate 45 in which the teeth 50 extend vertically downwards to co-operate with the hydraulic stream and the floating objects of the supply channel 13.

The intermediate gate 45 is placed with respect to the supply channel 13 upstream of the receiving tank 12 so as to limit the number of accumulating channels 14, the outlets 15 of which issue into a downstream portion of the supply channel 13 downstream of the intermediate gate 45. In this manner, the distance that the floating objects must cover from the moment when a case intended to receive them is immersed in the receiving tank 12 is at most equal to the length of the downstream portion of the supply channel 13, i.e. to the distance extending between the intermediate gate 45 and the receiving tank 12. Furthermore, floating objects from an accumulating channel, the outlet 15 of which is upstream of the intermediate gate 45, can accumulate against this intermediate gate 45 in the active position whilst floating objects from an accumulating channel 14, the outlet 15 of which is downstream of the intermediate gate 45, are being used to fill a case in the receiving tank 12. There is nothing to prevent the provision of a plurality of intermediate gates 45 distributed along the supply channel 13 if the number of accumulating channels 14 justifies this in order to optimise the filling method even further.

The feeding device 21 is downstream of the intermediate gate 45 which is the most downstream and the closest to the receiving tank 12, i.e. which delimits the downstream portion of the supply channel 13, and can move in translation along the supply channel between this intermediate gate 45 and the receiving tank 12 so as to co-operate with the floating objects transported in the downstream portion of the supply channel 13.

FIG. 3 shows a step of a filling method in accordance with the invention during which floating objects are introduced into the supply channel 13 from an outlet 15 of an accumulating channel 14 located in the downstream portion of the supply channel 13, the holding gate of this outlet 15 being controlled in the top position. The feeding gate 37 is placed immediately upstream of this outlet 15. Since the floating objects are forced along by the hydraulic stream of the accumulating channel 14 which arrives perpendicularly to the hydraulic stream flowing in the supply channel 13, these floating objects spill out into the supply channel 13, spreading out without taking up the entire width thereof. As long as the photoelectric cells 43 detect the presence of floating objects immediately downstream of the feeding gate 37, this gate is kept fixed with respect to the supply channel 13.

When the photoelectric cells 43 no longer detect the presence of floating objects immediately downstream of the feeding gate 37, the self-propelled carriage (and thus the feeding gate 37) is forced to move downstream at a mechanical forced-movement speed greater than the hydraulic forced-movement speed of the objects by the hydraulic stream, so as to catch up with the floating objects. When the feeding gate 37 thus comes into contact with the floating objects, as detected by the photoelectric cells 43, the downstream movement speed of the self-propelled carriage can be further increased to cause the forced supply of the objects into the tank and into the case 10 which it contains.

FIG. 5 thus shows a step of the filling method during which, when all of the floating objects of the batch of floating objects initially contained in the accumulating channel 14 have passed into the supply channel 13, the feeding device 21 is forced downstream with respect to the supply channel 13, the self-propelled carriage moving horizontally at a speed greater than the hydraulic forced-movement speed of the objects in the hydraulic stream of the supply channel 13, and in particular at a speed greater than the flowrate of the hydraulic stream flowing in the supply channel 13, the feeding gate 37 pushing the floating objects downstream in the hydraulic stream flowing in the supply channel 13, which has the effect of accelerating the movement speed thereof and causing them to take up the entire width of the supply channel 13. This step is carried out until the feeding gate 37 arrives immediately at the inlet of the receiving tank 12 to repel all of the floating objects into the case immersed in this receiving tank 12.

During a subsequent step of the filling method, the feeding device 21 is returned upstream so as to be able to co-operate with floating objects from another hydraulic channel 14, the outlet 15 of which issues into the downstream portion of the supply channel 13, or with floating objects arriving in this downstream portion from the intermediate gate 45 in the inactive position. Simultaneously, the case which has been filled with floating objects can be taken away and replaced by an empty case in the receiving tank 12.

FIG. 6 shows a batch of floating objects accumulating immediately upstream of the intermediate gate 45 in the active position, the feeding device 21 being thus placed immediately downstream of the intermediate gate 45, the feeding gate 37 being in the inactive position. These floating objects may have accumulated against the intermediate gate 45 whilst other floating objects were being used to fill a case immersed in the receiving tank 12.

FIG. 7 shows a subsequent step of the filling method during which the mobile intermediate gate 47 is placed in the inactive position to release the floating objects downstream, these objects being forced by the hydraulic stream into the downstream portion of the supply channel 13, passing beneath the mobile intermediate gate 47 and beneath the feeding gate 37, these two gates being in the inactive position. This taking place, the photoelectric cells 43 of the feeding device 21 detect the presence of floating objects in the supply channel. As soon as the photoelectric cells 43 no longer detect floating objects, the feeding device 21 is forced to move downstream at a speed greater than that of the hydraulic stream so as to come back into contact with floating objects to repel them towards the receiving tank 12.

Preferably, in order to facilitate filling of the case immersed in the receiving tank 12, the base 53 of the supply channel 13 has a cross-section restriction 57 at its downstream end in communication with the receiving tank 12. This cross-section restriction 57 is formed by a protuberance on the base 53 such that the height of the hydraulic stream passing above this cross-section restriction 57 is adapted to allow the passing of a single layer of floating objects. This cross-section restriction 57 allows the hydraulic stream to be locally accelerated and thus the speed of the floating objects to be increased immediately prior to them passing into the case immersed in the receiving tank 12.

Furthermore, the pumping circuit of the filling device preferably comprises an outlet 56 of the hydraulic stream in the lower part of the tank 12, beneath the immersed case 10, such that the hydraulic stream of the supply channel 13 arriving in the tank flows downwards in the tank and through the case immersed therein.

A feeding device 21 of a filling device in accordance with the invention allows forced supply (force-feeding) of the receiving tank 12 with floating objects during at least part of the step of supplying this receiving tank 12 and the immersed case contained therein with such floating objects. The movement speed of the feeding device 21 downstream, which is greater than the hydraulic forced-movement speed of the floating objects in the hydraulic stream of the supply channel, and preferably greater than the flowrate of the hydraulic stream in the supply channel, can be constant or, in contrast, can be variable over time and/or based on the position of the feeding device 21 along the supply channel 13. The ratio between the speed of the feeding device 21 downstream and the speed of the hydraulic stream can be of any magnitude so long as it is greater than 1.

In some advantageous embodiments, it is possible e.g. to provide two different forced-movement speeds downstream of the feeding device 21: a first speed selected to allow the feeding gate 37 to catch up with floating objects in order to come into contact therewith without risk of damaging them; and a second quicker speed selected to mechanically force these floating objects downstream, bringing the objects together and distributing the objects width-wise across the entire width of the supply channel 13 upstream of their arrival at the receiving tank 12.

For example, with open crates (palox) allowing the reception of 350 kg of apples, the feeding gate 37 can be driven at a speed between 20 and 50 m/min, in particular of the order of 30 to 40 m/min whilst the hydraulic stream in the supply channel 13 flows at a rate between 10 and 40 m/min, in particular of the order of 15 to 25 m/min. It has been noted that the time taken to fill a case with apples was able to be reduced from a time period of the order of 60 seconds to a time period of the order of 40 seconds, and that a sorting device fitted with such a filling device in accordance with the invention can operate at a rate which has been increased by 10 cases per hour to achieve a rate of 40 cases per hour, i.e. an increase of the order of 33% with respect to a conventional filling device and filling method not part of the invention.

It goes without saying that the invention can be varied in a large number of ways with respect to the sole embodiments described above and illustrated in the figures. Each feeding device can be formed in a large number of other structural embodiments so long as its allows the floating objects to be forced to move downstream at a speed greater than that of the hydraulic stream. In particular, each feeding gate can be forced to move by any motor-driven forced-movement mechanism other than a self-propelled carriage rolling on at least one sidewall of the supply channel. There is nothing to prevent the provision of a plurality of feeding devices, in particular a plurality of successive feeding devices distributed along the supply channel 13 and separated by one or more intermediate gates and/or several feeding devices moving in a single portion of the supply channel 13 and controlled to move in a continuous loop (e.g. supported and driven not individually by a self-propelled carriage, but collectively by a carrousel or any other motor-driven forced-movement mechanism) along a single path to the receiving tank 12. There is nothing to prevent the provision of several supply channel 13, in parallel or non-parallel with each other, each supply channel 13 communicating with a tank 12 and/or at least one tank 12 able to receive floating objects from several supply channels 13 and/or a tank 12 which can contain several immersed cases 10 . . . .

Furthermore, the logic for controlling each feeding device can be varied in a large number of ways. Therefore, each feeding device can be used and implemented during the entire process of filling each case, or in contrast only during some of the time period necessary for filling each case, e.g. only at the end of filling, or only for some floating objects or based on the number of floating objects contained in a case or to be introduced into a case, or based on any other suitable criteria.

The invention can also advantageously be applied to filling immersed cases such as open crates or palox pallets with fruit or vegetables. It can likewise be applied to filling other types of cases and/or other floating objects for which the same problems arise.

1. A method for hydraulically filling cases with objects, named floating objects, able to be transported by a hydraulic stream, said method comprising the steps of:
at least one case to be filled is immersed in a receiving tank,
during a step of supplying the tank with floating objects, said floating objects are transported to the tank by a hydraulic stream of a supply channel communicating with the tank above an immersed case,
wherein during at least part of the supplying step, at least some of the floating objects are mechanically forced to move downstream in the hydraulic stream of the supply channel at a mechanical forced-movement speed which is greater than their forced-movement speed, named hydraulic forced-movement speed, downstream solely under the effect of the hydraulic stream, so as to repel them downstream towards the tank and to accelerate their movement speed in the hydraulic stream towards the tank.

2. The method according to claim 1, wherein said floating objects mechanically forced to move downstream are mechanically forced downstream in the hydraulic stream at a speed greater than the flowrate of the hydraulic stream in the supply channel.

3. The method according to claim 1, wherein, in order to mechanically force floating objects to move downstream, at least one gate, named feeding gate, adapted to be able to mechanically force floating objects in the hydraulic stream downstream, is forced to move downstream with respect to the supply channel at a speed selected to come into contact with floating objects in the hydraulic stream, to repel them and to accelerate the movement thereof towards the tank.

4. The method according to claim 1, wherein all of the floating objects of a single batch of floating objects intended to fill a single case are mechanically forced to move downstream in the hydraulic stream of the supply channel.

5. The method according to claim 3, wherein the floating objects of a batch of floating objects intended to fill a single case are introduced into the supply channel progressively one behind the other, and in that a feeding gate is placed immediately upstream of the last floating objects of this batch introduced into the supply channel, then this feeding gate is forced to move downstream in the hydraulic stream.

6. The method according to claim 5, wherein the floating objects are introduced on one side of the supply channel in a direction transverse to this supply channel.

7. A device for hydraulically filling cases with objects, named floating objects, able to be transported by a hydraulic stream, comprising:
a tank for receiving at least one case to be filled,
at least one supply channel communicating with the tank above a case immersed in the tank,
a pumping circuit able to maintain a hydraulic stream in each supply channel, the hydraulic stream being suitable to transport floating objects to the tank,
wherein said device comprises a feeding device adapted to be able, at least during part of a step of supplying the tank with floating objects, to mechanically force at least some of the floating objects to move downstream in the hydraulic stream of the supply channel at a mechanical forced-movement speed which is greater than their forced-movement speed, named hydraulic forced-movement speed, downstream solely under the effect of the hydraulic stream, so as to repel them downstream towards the tank and to accelerate their movement speed in the hydraulic stream towards the tank.

8. The device according to claim 7, wherein the feeding device is adapted to be able to mechanically force floating objects to move downstream at a mechanical forced-movement speed greater than the flowrate of the hydraulic stream in the supply channel.

9. The device according to claim 7, wherein the feeding device comprises at least one gate, named feeding gate, adapted to be able to mechanically force floating objects in the hydraulic stream downstream, and a mechanism for forcing each feeding gate to move downstream with respect to the supply channel at a speed selected such that the feeding gate comes into contact with floating objects in the hydraulic stream, repels them and accelerates the movement thereof towards the tank.

10. The device according to claim 9, wherein said device has a feeding gate adapted to be able to be moved and introduced into the hydraulic stream of the supply channel in an introduction position located at a distance away from the tank determined such that a single batch of floating objects able to be contained within a single case and transported by the hydraulic stream can be fully contained between the introduction position of the feeding gate and the tank.

11. The device according to claim 7, wherein the feeding device comprises a self-propelled carriage adapted to be able to be moved in translation on at least one sidewall of the supply channel.

12. The device according to claim 7, wherein the supply channel has a cross-section restriction at one end in communication with the tank, and in that the feeding device comprises at least one feeding gate upstream of said cross-section restriction.

13. The device according to claim 7, wherein:
the supply channel extends along a plurality of outlets of a plurality of channels accumulating floating objects, these accumulating channels being in parallel with each other, each outlet of an accumulating channel communicating with the supply channel on one side thereof,
the supply channel comprises at least one gate, named intermediate gate, adapted to be able to be placed either in the active position in the supply channel in which it holds back the floating objects transported by the hydraulic stream upstream of the intermediate gate, or in an inactive position in which it does not co-operate with floating objects in the hydraulic stream,
it comprises a feeding gate between the tank and such an intermediate gate located most downstream in the supply channel.

14. The device for sorting floating objects such as fruit or vegetables, comprising:
at least one conveyor for sorting floating objects in accordance with predetermined sorting criteria and adapted to discharge floating objects into hydraulic accumulating channels,
at least one device for hydraulically filling cases with floating objects, comprising:
a tank for receiving at least one case to be filled,
at least one channel for supplying a hydraulic stream extending between outlets of the accumulating channels and the receiving tank, each supply channel being able to transport floating objects exiting an accumulating channel, and communicating with the tank above a case immersed in the tank,
a pumping circuit able to maintain a hydraulic stream in each accumulating channel and in each supply channel, the hydraulic stream being suitable to transport floating objects to each receiving tank,
wherein each device for hydraulically filling cases is a filling device according to claim 7.
